(19) United States
(12) Patent Application Publication
(10) Pub. No.: US 2009/0040142 A1
(43) Pub. Date: Feb. 12, 2009

(54) PLASMA DISPLAY DEVICE AND METHOD OF DRIVING THE SAME

(76) Inventor: Sang-Gu Lee, Suwon-si (KR)

Correspondence Address: CHRISTIE, PARKER & HALE, LLP, PO BOX 7068, PASADENA, CA, 91109-7068, US

(21) Appl. No.: 12/176,180

(22) Filed: Jul. 18, 2008

(30) Foreign Application Priority Data
Aug. 9, 2007 (KR) 10-2007-0080104

(51) Int. Cl. G09G 3/28

(52) U.S. Cl. 345/60; 345/211

(57) ABSTRACT

A plasma display device including a plasma display panel having a plurality of electrodes, an address electrode driver, a sustain electrode driver, and a scan electrode driver having a first transistor is provided. The first transistor is coupled between an electrode of the plurality of electrodes and a power source for supplying a first voltage. During a falling period of a reset period, a first driver gradually reduces a voltage of the electrode by controlling driving of the first transistor, and a second driver turns off the first transistor when a voltage generated by dividing a voltage of the electrode becomes lower than a reference voltage, thereby sustaining the voltage of the electrode at a second voltage different from the first voltage. Accordingly, different voltages can be applied to the electrode using one power source.

### CROSS-REFERENCE TO RELATED APPLICATION

This application claims priority to and the benefit of Korean Patent Application No. 10-2007-0080104 filed in the Korean Intellectual Property Office on Aug. 9, 2007, the entire content of which is incorporated herein by reference.

### BACKGROUND OF THE INVENTION

1. Field of the Invention

The present invention relates to a plasma display device and a method of driving the same.

2. Description of the Related Art

A plasma display device is a display device that uses a plasma display panel (PDP) for displaying characters or images using plasma that is generated by a gas discharge. In the PDP, a plurality of discharge cells are arranged in a matrix format.

In general, in a plasma display device, one frame is divided into a plurality of subfields for driving the plasma display device, and images having graylevels are displayed by a combination of a weight value of a subfield in which a display operation is performed among a plurality of subfields. During an address period of each subfield, light emitting cells and non-light emitting cells are selected by an address discharge, and during a sustain period, an image is displayed by a sustain discharge that is performed in the light emitting cells.

When a voltage difference between two electrodes are set to more than a predetermined voltage, a discharge is generated. During an address period and a sustain period, a level of a voltage that is applied to each electrode is different, whereby the number of power sources for supplying the voltages increases.

The above information disclosed in this Background section is only for enhancement of understanding of the background of the invention, and therefore it may contain information that does not form the prior art that is already known in this country to a person of ordinary skill in the art.

### SUMMARY OF THE INVENTION

Embodiments of the present invention provide a plasma display device and a method of driving the same having reduced number of power sources.

According to a first embodiment of the present invention, a plasma display device is provided. The plasma display device includes a plasma display panel having a plurality of electrodes, an address electrode driver, a sustain electrode driver, and a scan electrode driver. The scan electrode driver includes a first transistor, a first driver and a second driver. The first transistor has a first terminal coupled to an electrode of the plurality of electrodes and a second terminal coupled to a first power source for supplying a first voltage. The first driver controls driving of the first transistor to change a voltage of the electrode. The second driver includes a comparator having an output terminal and a plurality of first resistors coupled in series between the electrode and the first power source. The comparator is configured to output a high level voltage or a low level voltage to its output terminal by comparing a voltage generated by dividing a voltage of the electrode by the plurality of first resistors with a reference voltage. The second driver sustains the voltage of the electrode at a second voltage that is different from the first voltage by turning off the first transistor during a first period in response to an output voltage of the comparator.

According to another embodiment of the present invention, a method of driving a plasma display device is provided. The plasma display device includes a plasma display panel having a plurality of electrodes, an address electrode driver, a sustain electrode driver, and a scan electrode driver having a first transistor. A voltage of an electrode of the plurality of electrodes is changed by turning on the first transistor coupled between the electrode and a power source for supplying a first voltage during a first period of a reset period. A voltage generated by dividing a voltage of the electrode by a first resistor and a second resistor is compared with a reference voltage. The first resistor and the second resistor are coupled in series between the electrode and the power source. The voltage of the electrode is sustained at a second voltage during a second period of the reset period by turning off the first transistor when the divided voltage is lower than the reference voltage.

### BRIEF DESCRIPTION OF THE DRAWINGS

FIG. 1 is a block diagram illustrating a configuration of a plasma display device according to an exemplary embodiment of the present invention.

FIG. 2 is a diagram illustrating a driving waveform of a plasma display device according to an exemplary embodiment of the present invention.

FIG. 3 is a schematic diagram illustrating a scan electrode driving circuit according to a first exemplary embodiment of the present invention.

FIG. 4 is a timing chart of the driving circuit shown in FIG. 3.

FIGS. 5 and 6 are schematic diagrams respectively illustrating scan electrode driving circuits according to second and third exemplary embodiments of the present invention.

FIG. 7 is a schematic diagram illustrating a scan electrode driving circuit according to a fourth exemplary embodiment of the present invention.

FIG. 8 is a driving timing chart of the scan electrode driving circuit shown in FIG. 7.

FIGS. 9 and 10 are schematic diagrams respectively illustrating scan electrode driving circuits according to fifth and sixth exemplary embodiments of the present invention.

FIG. 11 is a schematic diagram illustrating a scan electrode driving circuit according to the seventh exemplary embodiment of the present invention.

FIG. 12 is a timing chart of the scan electrode driving circuit shown in FIG. 11.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. When it is described that an element is “connected” or “coupled” to another element, the element may be “directly connected” to the other element or “connected” to the other element through a third element.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed in design constraints or in the case that the variance is caused due to a parasitic component that is usually disregarded by a person of ordinary skill in the art. Further, because a threshold voltage of a semiconductor element (transistor, diode, etc.) is much lower than a discharge voltage, a threshold voltage is regarded as 0V voltage and approximately processed. Therefore, a voltage that is applied to a node, electrode, etc. by a power source includes a voltage of the power source, a threshold voltage, and a voltage that is varied by a parasitic component.

Here, a plasma display device according to an exemplary embodiment of the present invention is described in detail.

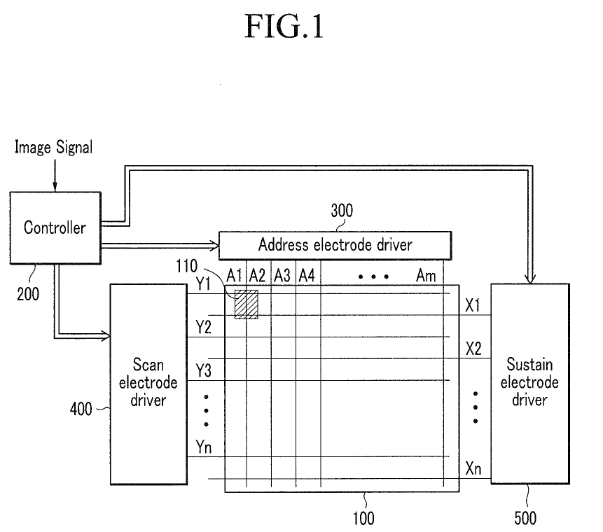

FIG. 1 is a block diagram illustrating a configuration of a plasma display device according to an exemplary embodiment of the present invention.

As shown in FIG. 1, the plasma display device according to an exemplary embodiment of the present invention includes a PDP 100, a controller 200, an address electrode driver 300, a scan electrode driver 400, and a sustain electrode driver 500.

The PDP 100 includes a plurality of address electrodes (hereinafter, referred to as “A electrodes”) A1-Am that extend in a column direction, and a plurality of sustain electrodes (hereinafter, referred to as “X electrodes”) X1-Xn and scan electrodes (hereinafter, referred to as “Y electrodes”) Y1-Yn that extend in a row direction while forming pairs of X1-Y1, X2-Y2, . . . , and Xn-Yn electrodes. In general, the X electrodes X1-Xn are formed to correspond to each of the Y electrodes Y1-Yn, and the X electrodes X1-Xn and the Y electrodes Y1-Yn perform a display operation for displaying an image in a sustain period. The Y electrodes Y1-Yn and the X electrodes X1-Xn are orthogonal to the A electrodes A1-Am. A cell 110 is formed in a discharge space that is formed at crossings of one of the A electrodes A1-Am and one of each of the X and Y electrodes X1-Xn and Y1-Yn. The PDP 100 only illustrates one exemplary structure according to an exemplary embodiment, and the present invention can be applied to a panel of other structures to which a driving waveform can be applied.

The controller 200 receives a video signal from the outside of the plasma display device to output a driving control signal of the A electrode, the X electrode, and the Y electrode, divides one frame into a plurality of subfields each having luminance weight value, and drives the subfields.

The address electrode driver 300 applies a driving voltage to the plurality of A electrodes A1-Am according to a driving control signal from the controller 200.

The scan electrode driver 400 applies a driving voltage to a plurality of Y electrodes Y1-Yn according to a driving control signal from the controller 200.

The sustain electrode driver 500 applies a driving voltage to a plurality of X electrodes X1-Xn according to a driving control signal from the controller 200.

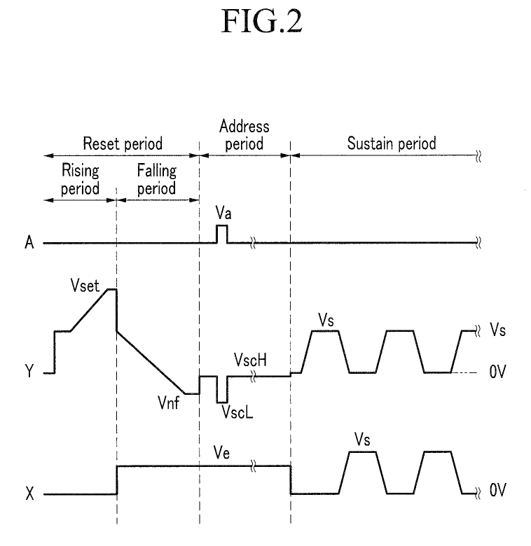

FIG. 2 is a diagram illustrating a driving waveform of a plasma display device according to an exemplary embodiment of the present invention. In FIG. 2, for better understanding and ease of description, only a driving waveform of one subfield of a plurality of subfields constituting one frame is described, and only a driving waveform that is applied to the X electrode, the Y electrode, and the A electrode forming one discharge cell is described.

As shown in FIG. 2, during a rising period of a reset period, the address electrode driver 300 and the sustain electrode driver 500 respectively bias the A electrode and the X electrode to a reference voltage (0V in FIG. 2), and the scan electrode driver 400 gradually increases a voltage of the Y electrode from a Vs voltage to a Vset voltage. FIG. 2 shows that a voltage of the Y electrode increases in a ramp pattern. Accordingly, while the voltage of the Y electrode increases, as a feeble discharge (hereinafter, referred to as a “weak discharge”) is generated between the Y electrode and the X electrode and between the Y electrode and the A electrode, a negative (−) wall charge is formed on the Y electrode, and a positive (+) wall charge is formed on the X and A electrodes.

In a falling period of a reset period, the sustain electrode driver 500 biases the X electrode to a Ve voltage, and the scan electrode driver 400 gradually decreases the voltage of the Y electrode from a Vs voltage to a Vnf voltage. FIG. 2 shows that the voltage of the Y electrode reduces in a ramp pattern. Accordingly, while the voltage of the Y electrode decreases, as a weak discharge is generated between the Y electrode and the X electrode and between the Y electrode and the A electrode, and a negative (−) wall charge that is formed on the Y electrode and a positive (+) wall charge that is formed on the X electrode and the A electrode are erased. In general, in an address period, a Ve voltage and a Vnf voltage are set to make the wall voltage between the Y electrode and the X electrdoe of an unselected cell to be almost 0V, such that a sustain discharge is not generated in a sustain period. That is, a Ve-Vnf voltage is set to about a discharge firing voltage between the Y electrode and the X electrode.

Next, in an address period, when the sustain electrode driver 500 biases the voltage of the X electrode to a Ve voltage, in order to select a light emitting cell, the scan electrode driver 400 and the address electrode driver 300 apply a scan pulse having a VscL voltage and an address pulse having a Va voltage to the Y electrode and the A electrode, respectively. The unselected Y electrode is biased to a VscH voltage that is higher than a VscL voltage, and a reference voltage is applied to the A electrode of a non-light emitting cell.

When a Vnf voltage is applied to the Y electrode in a reset period, a sum of a wall voltage between the A electrode and the Y electrode and an external voltage Vnf between the A electrode and the Y electrode is determined by a discharge firing voltage between the A electrode and the Y electrode. In an address period, when 0V is applied to the A electrode and a VscL (e.g., VscL=Vnf) voltage is applied to the Y electrode, even though a discharge firing voltage between the A electrode and the Y electrode is formed between the A electrode and the Y electrode, a discharge is not generated because a discharge delay time is longer than widths of a scan pulse and an address pulse, a discharge is not generated. However, when a Va voltage is applied to the A electrode and a VscL (e.g., VscL=Vnf) voltage is applied to the Y electrode, a voltage higher than a discharge firing voltage between the A electrode and the Y electrode is formed between the A electrode and the Y electrode, whereby a discharge delay time becomes smaller than a width of a scan pulse, so that a discharge can be generated. In this case, if the VscL voltage is set to a voltage lower than the Vnf voltage, a voltage difference VscL-Va between the Y electrode and the A electrode increases, and thus an address discharge is more easily generated. Further, the Va voltage can be lowered by a voltage difference VscL-Vnf. Therefore, in an address period, the VscL voltage is generally set to be equal to or lower than the Vnf voltage, and the Va voltage is set to be higher than the reference voltage.

In more detail, in an address period, the scan electrode driver 400 applies a scan pulse to an Y electrode (e.g., Y1 of FIG. 1) of a first row, and the address electrode driver 300 concurrently applies an address pulse to the A electrode that corresponds to a light emitting cell of the first row. Accordingly, because an address discharge is generated between the Y electrode of the first row and the A electrode to which an address pulse is applied, a positive (+) wall charge is formed on the Y electrode, and a negative (−) wall charge is formed on the A and X electrodes. Thereafter, the address electrode driver 300 applies an address pulse to the A electrode that corresponds to a light emitting cell of a second row while the scan electrode driver 400 applies a scan pulse to the Y electrode (e.g., Y2 of FIG. 1) of the second row. Accordingly, because an address discharge is generated in a cell that is formed by the A electrode to which an address pulse is applied and the Y electrode of the second row, a wall charge is generated in a cell. Similarly, the address electrode driver 300 applies address pulses to the A electrodes that correspond to light emitting cells while the scan electrode driver 400 sequentially applies a scan pulse to the Y electrodes of the remaining rows, thereby generating wall charges.

Thereafter, in a sustain period, the scan electrode driver 400 applies a sustain pulse alternately having a high level voltage (e.g., Vs voltage in FIG. 2) and a low level voltage (e.g., 0V in FIG. 2) to the Y electrode by the number of times corresponding to a weight value of the corresponding subfield. The sustain electrode driver 500 applies a sustain pulse to the X electrode with a phase opposite to the sustain pulse that is applied to the Y electrode. Accordingly, a voltage difference between the Y electrode and the X electrode alternately has a Vs voltage and a −Vs voltage, and thus a sustain discharge is repeatedly generated in a light emitting cell in accordance with the number of sustain pulses that are applied.

FIG. 2 shows that a sustain pulse having a Vs voltage is alternately applied to the Y electrode and the X electrode. Alternatively, a sustain pulse alternately having a Vs voltage and a −Vs voltage may be applied to the Y electrode and/or the X electrode. For example, when the X electrode is biased at a ground voltage, a sustain discharge pulse alternately having a Vs voltage and a −Vs voltage may be applied to the Y electrode.

Further, in FIG. 2, after initializing a cell as a non-light emitting cell by erasing a wall charge of the cell in the reset period, the cell is set as a light emitting cell by performing an address discharge in the address period. Alternatively, after writing a wall charge to the cell in the reset period, to set the cell as a light emitting cell or after a sustain period of a pervious subfield, in an address period, the cell may be set to a non-light emitting cell by performing an address discharge.

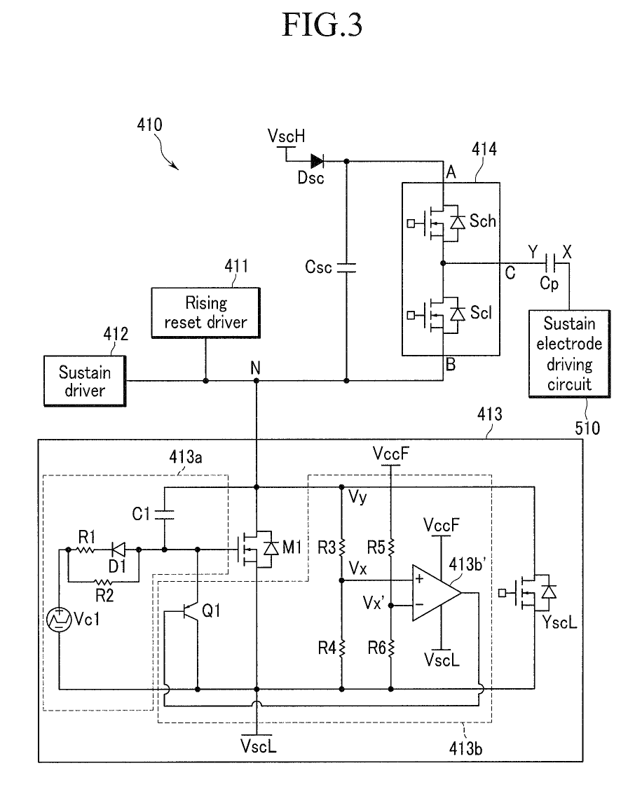

Referring to FIGS. 3 to 10, exemplary driving circuits for supplying different levels of voltages using one power source are described in detail according to embodiments of the present invention. FIGS. 3 to 10 show exemplary embodiments that can supply a Vnf voltage that is applied to the Y electrode in the reset period and a VscL voltage that is applied to the Y electrode in the address period using one power source.

FIG. 3 is a schematic diagram illustrating a scan electrode driving circuit 410 according to a first exemplary embodiment of the present invention. The scan electrode driving circuit 410 can be part of the scan electrode driver 400, and a sustain electrode driving circuit 510 that is coupled to the X electrode can be part of the sustain electrode driver 500. For better understanding and ease of description, only one Y electrode is described, and a capacitive component that is formed by one Y electrode and one X electrode is illustrated as a panel capacitor Cp. It is assumed that a Vs voltage is applied to the Y electrode before a falling ramp waveform is applied in a falling period.

As shown in FIG. 3, the scan electrode driving circuit 410 according to the first exemplary embodiment of the present invention includes a rising reset driver 411, a sustain driver 412, a falling reset/scan driver 413, a scanning circuit 414, a capacitor Csc, and a diode Dsc.

First, the scanning circuit 414 has a high side input terminal A and a low side input terminal B, an output terminal C thereof is coupled to the Y electrode, and in order to select a cell to be lighted in an address period, a voltage of the high side input terminal A and a voltage of the low side input terminal B are selectively applied to the corresponding Y electrode. FIG. 3 shows one scanning circuit 414 that is coupled to the Y electrode, and each scanning circuit 414 is coupled to a plurality of Y electrodes (Y1-Yn of FIG. 1). Because a predetermined number of scanning circuits 414 are formed in one integrated circuit, and each of a plurality of output terminals of the integrated circuit may be coupled to a predetermined number of the Y electrodes (for example, Y1-Yk, where k is an integer smaller than n). The scanning circuit 414 includes transistors Sch and Scl. The source of the transistor Sch and the drain of the transistor Scl are coupled to the Y electrode of the panel capacitor Cp. The drain of the transistor Sch is coupled to the high side input terminal A, and the source of the transistor Scl is coupled to the low side input terminal B. A power source VscH for supplying a VscH voltage is coupled to the high side input terminal A of the scanning circuit 414 through a diode Dsc, and a cathode of the diode Dsc whose anode is coupled to the power source VscH is coupled to the high side input terminal A of the scanning circuit 414. A capacitor Csc is coupled between the high side input terminal A of the scanning circuit 414 and the low side input terminal B of the scanning circuit 414.

The falling reset/scan driver 413 is coupled to a node N, and the node N is coupled to the low side input terminal B of the scanning circuit 414. The falling reset/scan driver 413 includes transistors M1 and YscL and drivers 413a and 413b. FIG. 3 shows transistors M1, YscL, Sch, and Scl as an N-channel field effect transistor, particularly an N-channel metal oxide semiconductor (NMOS) transistor, and the transistor Q1 is shown as a PNP-type transistor, however other transistor types having a similar function may be used as the transistors M1, YscL, Sch, and Scl. The driver 413a includes a capacitor C1, resistors R1 and R2, a diode D1, and a control signal voltage source Vc1, and the driver 413b includes a transistor Q1, resistors R3, R4, R5, and R6, and a comparator 413b′.

A power source VscL for supplying a VscL voltage is coupled to the source of the transistor M1 whose drain is coupled to the node N. A first terminal of the capacitor C1 is coupled to the drain of the transistor M1, and a second terminal of the capacitor C1 is coupled to the gate terminal of the transistor M1, which is a control terminal. The resistor R1 is coupled to a cathode of the diode D1 whose anode is coupled to the second terminal of the capacitor C1, a positive terminal of the control signal voltage source Vc1 is coupled to the resistor R1, and a negative terminal of the control signal voltage source Vc1 is coupled to the power source VscL. Further, the resistor R2 is coupled between the resistor R1 and an anode of the diode D1. The transistor M1 driven by the driver 413a can decrease a voltage of the Y electrode in a ramp pattern.

The two resistors R3 and R4 are coupled in series between the drain of the transistor M1 and the power source VscL, and the two resistors R5 and R6 are coupled in series between a power source VccF for supplying a VccF voltage and the power source VscL. Here, the VccF voltage is higher by a predetermined voltage (for example, 15V) than the VscL voltage. A contact point between the two resistors R3 and R4 is coupled to a non-inverting input terminal (+) of the comparator 413b′, and a contact point between the two resistors R5 and R6 is coupled to an inverting input terminal (−) of the comparator 413b′. An output terminal of the comparator 413b′ is coupled to the base terminal of the transistor Q1, which is a control terminal. The collector of the transistor Q1 is coupled to the power source VscL, and the emitter of the transistor Q1 is coupled to the gate of the transistor M1. When the voltage of the Y electrode becomes a predetermined voltage, the driver 413b turns on the transistor Q1 to block the path between transistor M1 and the power source VscL.

The drain of the transistor YscL is coupled to the node N, and the source of the transistor YscL is coupled to the power source VscL. As the transistor YscL is turned on in an address period, a VscL voltage is supplied to the low side input terminal B of the scanning circuit 414.

The sustain driver 412, which is coupled to the node N, applies a sustain pulse alternately having a high level voltage (e.g., Vs voltage in FIG. 2) and a low level voltage (e.g., 0V in FIG. 2) to a plurality of Y electrodes Y through the low side input terminal B of the scanning circuit 414 during a sustain period. A rising reset driver 411, which is coupled to the node N, applies a rising reset waveform to the Y electrodes Y through the low side input terminal B of the scanning circuit 414 during a rising period of a reset period.

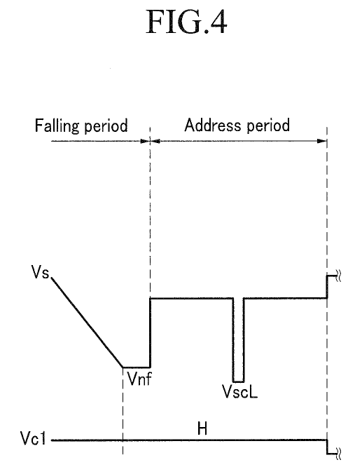

Next, referring to FIG. 4, operation of the falling reset/scan driver 413 that is shown in FIG. 3 is described in detail.

FIG. 4 is a timing chart of the driving circuit shown in FIG. 3. It is assumed that in a reset period, a transistor Scl of the scanning circuit 414 is always turned on to apply the voltage of the Y electrode of the panel capacitor Cp to the node N, and a Vs voltage is applied to the Y electrode.

As shown in FIG. 4, during a falling period of a reset period, a high level voltage H (i.e., a VccF voltage) is output from a control signal voltage source Vc1. Accordingly, a gate voltage of the transistor M1 increases by a capacitance component that is formed by the capacitor C1 and the parasitic capacitor of the transistor M1 and a path that is formed by the resistor R1. As the gate voltage of the transistor M1 increases, when the transistor M1 is turned on, the voltage of the Y electrode decreases through a path of the panel capacitor Cp, the transistor M1, and the power source VscL. As the voltage of the Y electrode decreases, the gate voltage of the transistor M1 decreases by the capacitor C1, and thus the transistor M1 is turned off.

As the gate voltage of the transistor M1 is increased again by the high level signal H, the transistor M1 is turned on again. Then the voltage of the Y electrode is decreased again.

In this way, the transistor M1 is repeatedly turned on and turned off, thereby gradually reducing the voltage of the Y electrode.

When it is assumed that the voltage of the Y electrode is Vy, the voltage Vy is divided by the resistors R3 and R4 to be Vx. A voltage (e.g., VccF) that is divided by the resistors R5 and R6 is Vx′. The Vx and Vx′ voltages are determined by Equations 1 and 2.

$$\begin{matrix}Vx = ( Vy - VscL ) \times \frac{R 4}{( R 3 + R 4 )} & Equation 1 \\ {Vx}^{′} = ( VccF - VscL ) \times \frac{R 6}{( R 5 + R 6 )} & Equation 2\end{matrix}$$

Here, when the Vx voltage is higher than the Vx′ voltage, the comparator 413b′ outputs the VccF voltage, which is a high level voltage, to the base of the transistor Q1. When the Vx voltage is lower than the Vx′ voltage, the comparator 413b′ outputs the VscL voltage, which is a low level voltage, to the base of the transistor Q1. When the VccF voltage is input to the base of the transistor Q1, the transistor Q1 is turned off, and when the VscL voltage is input to the base of the transistor Q1, the transistor Q1 is turned on.

Therefore, during a falling period of a reset period, while the voltage Vy of the Y electrode gradually decreases, the voltage Vy of the Y electrode will decrease to a voltage level that causes the Vx voltage to be lower than the Vx′ voltage. As a result, the transistor Q1 is turned on, and thus the transistor M1 is turned off. Therefore, the Y electrode can sustain any voltage Vy during a predetermined period. Here, the voltage Vy of the Y electrode can be determined to a Vnf voltage. When the voltage Vy of the Y electrode becomes a desired Vnf voltage, the values of the resistors R2, R3, R4, and R5 should be so selected such that the Vx voltage becomes lower than the Vx′ voltage, therefore the Vnf voltage is also adjusted. Before the voltage Vy of the Y electrode decreases to the Vnf voltage, the Vx voltage is higher than the Vx′ voltage, therefore the comparator 413b′ outputs a VccF voltage to the base of the transistor Q1. Thus, the transistor Q1 is turned off.

Thereafter, in an address period, the transistor YscL is turned on. In this state, if the transistor Scl is turned on, a VscL voltage can be applied to the Y electrode of the light emitting cell.

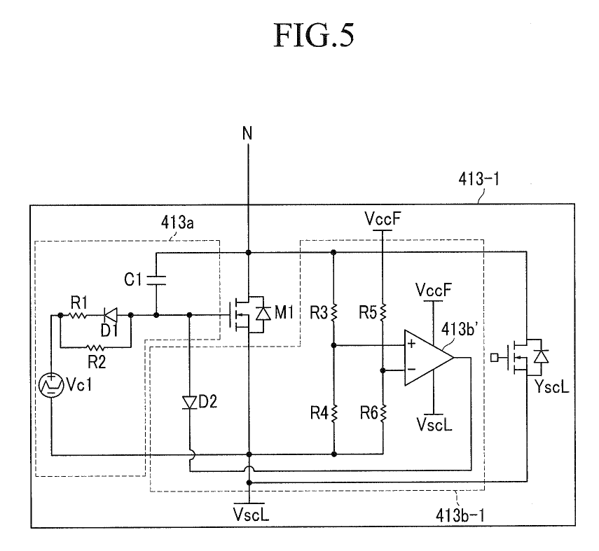

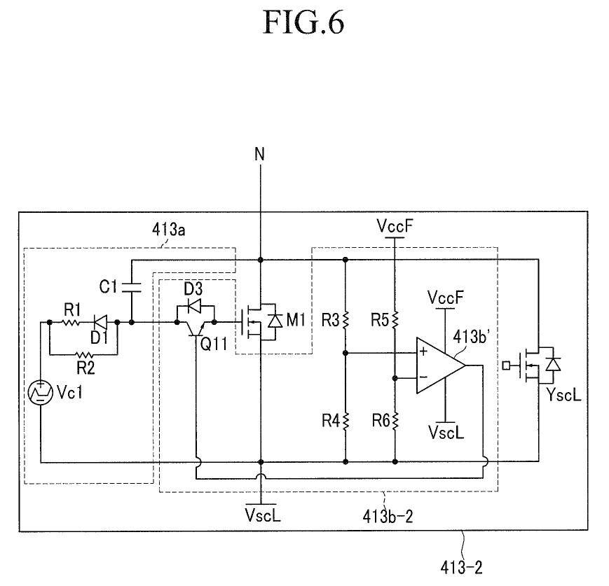

FIGS. 5 and 6 are diagrams respectively illustrating scan electrode driving circuits according to second and third exemplary embodimentsof the present invention. For better understanding and ease of description, FIGS. 5 and 6 show only falling reset/scan drivers 413-1 and 413-2, respectively.

As shown in FIG. 5, the falling reset/scan driver 413-1 according to the second exemplary embodiment of the present invention is substantially teh same as the falling reset/scan driver 413 according to the first exemplary embodiment of the present invention, except for the driver 413b-1. In the driver 413b-1, instead of the transistor Q1 of the driver 413b shown in FIG. 3, a diode D2 is coupled between the gate of the transistor M1 and the output terminal of the comparator 413b′. That is, an anode of the diode D2 is coupled to the gate of the transistor M1, and a cathode of the diode D2 is coupled to the output terminal of the comparator 413b′.

The falling reset/scan driver 413-1 outputs the VccF voltage from the control signal voltage source Vc1 during a falling period of a reset period. Accordingly, as in the first exemplary embodiment, the voltage of the Y electrode is gradually decreased by repeatedly turning on/turning off the transistor M1. Because the Vx voltage is higher than a Vx′ voltage, the comparator 413b′ applies the VccF voltage to the cathode of the diode D2.

While the voltage of the Y electrode gradually decreases, when the voltage Vy of the Y electrode decreases to a voltage which causes the Vx voltage to be lower than the Vx′ voltage, the comparator 413b′ applies a VscL voltage to the cathode of the diode D2. Accordingly, because the gate voltage of the transistor M1 becomes the VscL voltage, the transistor M1 is turned off. Therefore, when the Vx voltage is equal to the Vx′ voltage, the voltage Vy of the Y electrode is determined to be a Vnf voltage, and during a period of time (e.g., a predetermined period), the Y electrode sustains a Vnf voltage.

In an address period, the transistor YscL is turned on. In this state, when the transistor Scl is turned on, the VscL voltage is applied to the Y electrode of the light emitting cell.

Further, as shown in FIG. 6, the falling reset/scan driver 413-2 according to the third exemplary embodiment of the present invention is substantially the same as the falling reset/scan driver 413 according to the first exemplary embodiment of the present invention, except for the driver 413b-2. The driver 413b-2 is similar to the driver 413b, except for a transistor Q11 and a diode D3. That is, the base of the transistor Q11 is coupled to the output terminal of the comparator 413b′, the collector of the transistor Q11 is coupled to the second terminal of the capacitor C1, and the emitter of the transistor Q11 is coupled to the gate of the transistor M1. The diode D3 is coupled between the emitter of the transistor Q11 and the collector of the transistor Q11. When the transistor Q11 is turned off, the diode D3 provides a discharge path for discharging the gate voltage of the transistor M1.

The falling reset/scan driver 413-2 outputs the VccF voltage from the control signal voltage source Vc1 during a falling period of a reset period. Before the Vx voltage becomes lower than the Vx′ voltage, the comparator 413b applies the VccF voltage to the base of the transistor Q11. Accordingly, the transistor Q11 is turned on, and as in the first exemplary embodiment, by repeatedly turning on/turning off the transistor M1, a voltage of the Y electrode gradually decreases. While the voltage of the Y electrode gradually decreases, when the voltage of the Y electrode decreases to a voltage which causes the Vx voltage to be lower than the Vx′ voltage, the comparator 413b′ supplies a VscL voltage to the base of the transistor Q11. Accordingly, the transistor Q11 is turned off, and thus the transistor M1 is also turned off. At this time, the voltage Vy of the Y electrode is determined to be a Vnf voltage, and during a period of time (e.g., a predetermined period), the Y electrode sustains a Vnf voltage. In an address period, the transistor YscL is turned on. In this state, when the transistor Scl is turned on, the VscL voltage can be applied to the Y electrode of the light emitting cell.

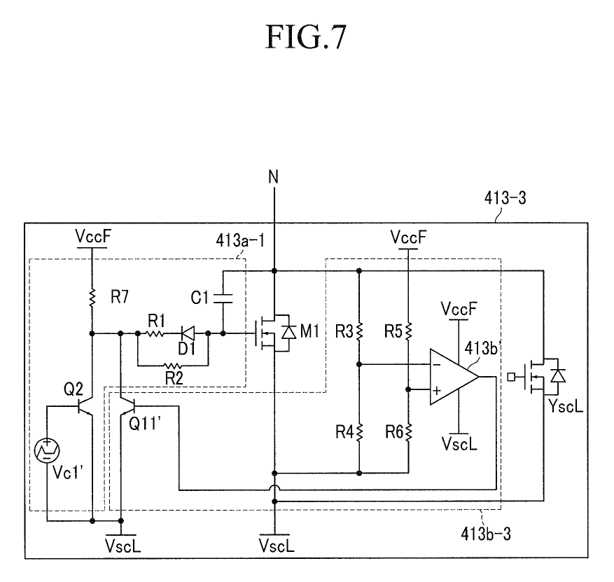

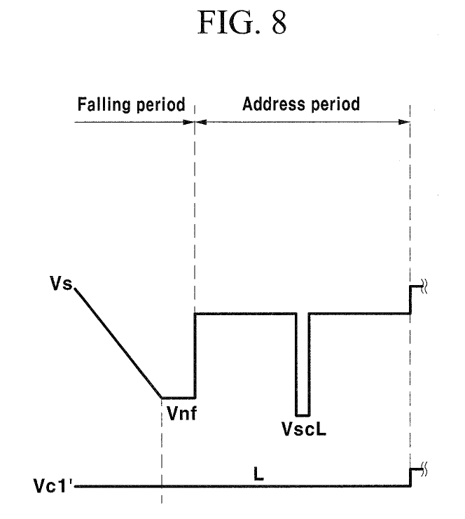

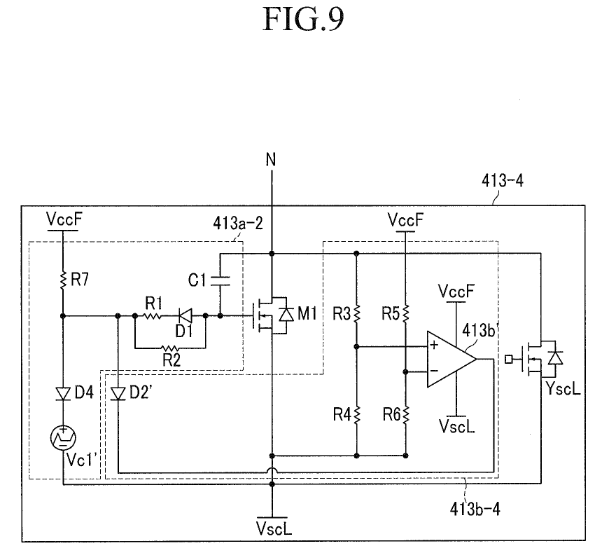

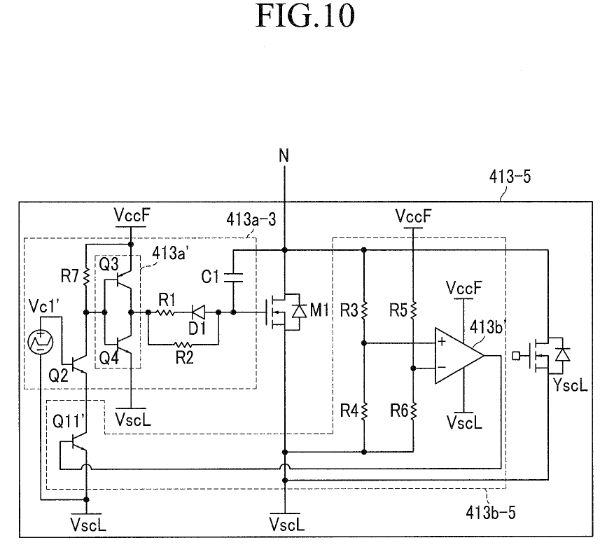

FIG. 7 is a schematic diagram illustrating a scan electrode driving circuit according to a fourth exemplary embodiment of the present invention. FIG. 8 is a driving timing chart of the scan electrode driving circuit shown in FIG. 7. FIGS. 9 and 10 are schematic diagrams respectively illustrating scan electrode driving circuits according to fifth and sixth exemplary embodiments of the present invention. In FIGS. 7, 9, and 10, for better understanding and ease of description, only falling reset/scan drivers 413-3, 413-4, and 413-5 are described.

Referring to FIG. 7, a driver 413a-1 of the falling reset/scan driver 413-3 according to the fourth exemplary embodiment of the present invention is similar to the driver 413a of the falling reset/scan driver 413 according to the first exemplary embodiment of the present invention, except for further including a transistor Q2 and a resistor R7. A collector of the transistor Q2 is coupled to the resistor R1, and an emitter of the transistor Q2 is coupled to the power source VscL. A base of the transistor Q2 is coupled to a positive terminal of a control signal voltage source Vc1′, and a negative terminal of the control signal voltage source Vc1′ is coupled to the power source VscL. Further, a resistor R7 is coupled between the power source VccF and the resistor R1.

Further, a driver 413b-3 of the falling reset/scan driver 413-3 is similar to the driver 413b of the falling reset/scan driver 413 according to the first exemplary embodiment of the present invention, except that the collector of the transistor Q11′ is coupled to the gate of the transistor M1, the emitter of the transistor Q11′ is coupled to the power source VscL, and the base of the transistor Q11′ is coupled to the output terminal of the comparator 413b′. Unlike the first exemplary embodiment of the present invention, the comparator 413b′ outputs a VscL voltage when a Vx voltage is higher than a Vx′ voltage, and outputs a VccF voltage when a Vx voltage is lower than a Vx′ voltage.

As shown in FIG. 8, the falling reset/scan driver 413-3 outputs a low level voltage L (i.e., VscL voltage) from the control signal voltage source Vc1′. Accordingly, the transistor Q2 is turned off, and the VccF voltage is supplied to the gate of the transistor M1 through a path of the power source VccF and resistors R7 and R2. Therefore, during a falling period of a reset period, as in the first exemplary embodiment, the voltage Vy of the Y electrode gradually decreases by repeatedly turning on/turning off the transistor M1. Before the Vx′ voltage becomes lower than the Vx voltage, the comparator 413b′ outputs a VscL voltage to the base of the transistor Q11′, and the transistor Q11′ is turned off.

Thereafter, while the voltage Vy of the Y electrode gradually decreases, when the voltage Vy of the Y electrode decreases to a voltage which causes the Vx voltage to be lower than the Vx′ voltage, the comparator 413b′ outputs the VccF voltage to the base of the transistor Q1′. Accordingly, the transistor Q11′ is turned on, and the transistor M1 is turned off. In this case, the voltage Vy of the Y electrode is determined to be a Vnf voltage, and during a period of time (e.g., a predetermined period), the Y electrode sustains the Vnf voltage.

In an address period, the transistor YscL is turned on. In this state, when the transistor Scl is turned on, the VscL voltage is applied to the Y electrode of a light emitting cell.

Next, referring to FIG. 9, a driver 413a-2 of a falling reset/scan driver 413-4 according to the fifth exemplary embodiment of the present invention is similar to the driver 413a-1 of the falling reset/scan driver 413-3 according to the fourth exemplary embodiment of the present invention, except that a diode D4 instead of the transistor Q2 is coupled. That is, an anode of the diode D4 is coupled to the resistor R1, and a cathode of the diode D4 is coupled to a control signal voltage source Vcl′. A driver 413b-4 of the falling reset/scan driver 413-4 is also similar to the driver 413b-3 of the falling reset/scan driver 413-3, except that a diode D2′ instead of the transistor Q11′ is coupled. Unlike the fourth exemplary embodiment of the present invention, the comparator 413b′ outputs a VccF voltage when the Vx voltage is higher than the Vx′ voltage, and outputs a VscL voltage when the Vx voltage is lower than the Vx′ voltage.

Similar to the driving timing chart shown in FIG. 4, the falling reset/scan driver 413-4 outputs a high level voltage H (e.g., VccF voltage) from the control signal voltage source Vc1′ during a falling period of a reset period. Accordingly, the VccF voltage is supplied to a gate of the transistor M1 through a path of the power source VccF and the resistors R7 and R2, and by repeatedly turning on/turning off the transistor M1, the voltage Vy of the Y electrode gradually decreases. Before the Vx voltage becomes lower than the Vx′ voltage, the comparator 413b′ outputs the VccF voltage to the cathode of the diode D2′. Thereafter, while the voltage Vy of the Y electrode gradually decreases, when the voltage Vy of the Y electrode decreases to a voltage which causes the Vx voltage to be lower than the Vx′ voltage, the comparator 413b′ outputs the VscL voltage to the cathode of the diode D2′, whereby a current flows through the diode D2′. Therefore, the transistor M1 is turned off. That is, when the Vx voltage is equal to the Vx′ voltage, the voltage Vy of the Y electrode is determined to be the Vnf voltage, and during a period of time (e.g, a predetermined period, the Y electrode sustains a Vnf voltage.

In an address period, the transistor YscL is turned on. In this state, when the transistor Scl is turned on, the VscL voltage is applied to the Y electrode of the light emitting cell. As shown in FIG. 10, a driver 413a-3 of a falling reset/scan driver 413-5 according to the sixth exemplary embodiment of the present invention is similar to the driver 413a-1 of the falling reset/scan driver 413-3 according to the fourth exemplary embodiment of the present invention, except for further including a push-pull circuit 413a′. The push-pull circuit 413a′ includes a PNP-type transistor Q3 and an NPN-type transistor Q4. Each of the two transistors Q3 and Q4 has a collector and an emitter as two terminals and has a base as a control terminal. In the push-pull circuit 413a′, bases of the two transistors Q3 and Q4 are coupled to a contact point between the resistor R7 and a collector of the transistor Q2, the power source VccF is coupled to an emitter of the PNP-type transistor Q3, and the power source VscL is coupled to an emitter of the NPN-type transistor Q4. The collectors of the two transistors Q3 and Q4 form an output terminal of the push-pull circuit 413a′, and is coupled to the gate of the transistor M1 through the resistor R2. When a low level voltage (for example, VscL) is input to the control terminal of the push-pull circuit 413a′, the transistor Q3 is turned on, so that the gate voltage of the transistor M1 becomes the VccF voltage. Accordingly, the transistor M1 is turned on. However, when a high level voltage (for example, VccF) is input to the control terminal of the push-pull circuit 413a′, the transistor Q4 is turned on, so that the gate voltage of the transistor M1 becomes the VscL voltage. Accordingly, because the voltage between the gate and the source of the transistor M1 becomes 0V, the transistor M1 is turned off. In the sixth exemplary embodiment of the present invention, the push-pull circuit is used to apply a voltage to the gate of the transistor M1, however amplifiers having a function similar to the push-pull circuit may be applied in other embodiments of the present invention.

A driver 413b-5 of the falling reset/scan driver 413-5 is similar to the driver 413b-3 of the falling reset/scan driver 413-3 according to the fourth exemplary embodiment of the present invention, except that the emitter of the transistor Q11″ is coupled to an emitter of the transistor Q2. Unlike the fourth exemplary embodiment of the present invention, the comparator 413b′ outputs the VccF voltage when the Vx voltage is higher than the Vx′ voltage, and outputs the VscL voltage when the Vx voltage is lower than Vx′ voltage.

In a falling period of a reset period, the falling reset/scan driver 413-5 outputs the VccF voltage from the control signal voltage source Vc1′. Because the Vx voltage is higher than the Vx′ voltage, the VccF voltage is input to a base of the transistor Q11″. Accordingly, the two transistors Q1 and Q11″ are turned on, and a VscL voltage is input to bases of the two transistors Q3 and Q4. Accordingly, the transistor Q3 is turned on, and thus the transistor M1 is also turned on. As in the first exemplary embodiment, the voltage Vy of the Y electrode gradually decreases by repeatedly turning on/turning off the transistor M1.

While the voltage of the Y electrode gradually decreases, when the voltage Vy of the Y electrode decreases to a voltage which causes the Vx voltage to be lower than the Vx′ voltage, the comparator 413b′ outputs the VscL voltage to the base of the transistor Q11″. Accordingly, the transistor Q11″ is turned off, and the VccF voltage is input to the bases of the two transistors Q3 and Q4. Accordingly, the transistor Q4 is turned on, and the transistor M1 is turned off. That is, when the Vx voltage is equal to the Vx′ voltage, a voltage Vy of the Y electrode is determined to be a Vnf voltage, and during a period of time (e.g,. a predetermined period), the Y electrode sustains a Vnf voltage.

In an address period, the transistor YscL is turned on. In this state, when the transistor Scl is turns on, the VscL voltage is applied to the Y electrode of a light emitting cell.

According to the first to sixth exemplary embodiments of the present invention, the scan electrode driving circuit 410 can supply both the Vnf voltage and the VscL voltage using one power source VscL. Because only the VccF voltage or the VscL voltage is supplied using a control signal for turning off the transistor M1, although a threshold voltage of the transistors M1 and Q1 changes according to temperature change, the Vnf voltage does not change.

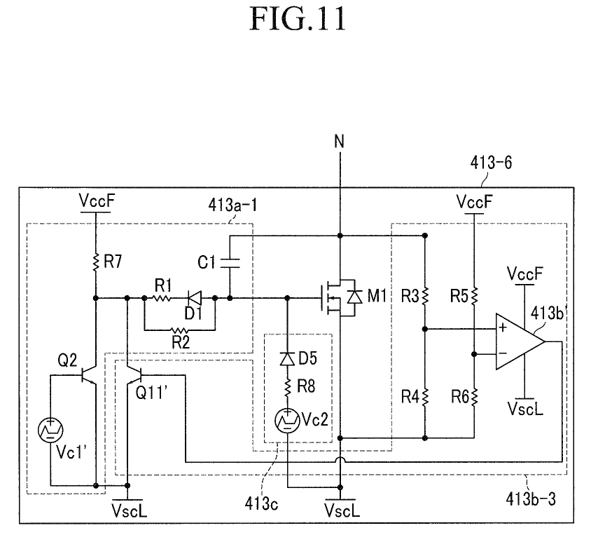

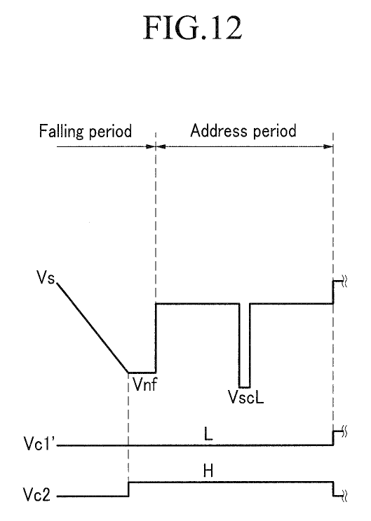

Next, unlike the first to sixth exemplary embodiments of the present invention, a method of applying the VscL voltage to the Y electrode without the transistor YscL in an address period is described in detail with reference to FIGS. 11 and 12.

FIG. 11 is a diagram illustrating a scan electrode driving circuit according to a seventh exemplary embodiment of the present invention. FIG. 12 is a timing chart of the scan electrode driving circuit shown in FIG.11.

As shown in FIG. 11, the falling reset/scan driver circuit 413-6 according to the seventh exemplary embodiment of the present invention is similar to the fourth exemplary embodiment of the present invention, except for further including a driver 413c instead of the transistor YscL. The driver 413c includes a diode D5, a resistor R8, and a control signal voltage source Vc2. The cathode of the diode D5 is coupled to the gate of the transistor M1, and the anode of the diode D5 is coupled to the positive terminal of the control signal voltage source Vc2. The negative terminal of the control signal voltage source Vc2 is coupled to the power source VscL, and the resistor R8 is coupled between the anode of the diode D5 and the control signal voltage source Vc2.

As shown in FIG. 12, the control signal voltage source Vc2 outputs a high voltage H (e.g., VccF voltage) during an address period. Accordingly, the transistor Ml is turned on. In this state, when the transistor Scl is turned on, the VscL voltage is applied to the Y electrode of a light emitting cell.

The seventh exemplary embodiment of the present invention does not have the transistor YscL and instead includes a driver 413c in comparison to the scan electrode driving circuit 413-3 according to the fourth exemplary embodiment of the present invention, however the seventh exemplary embodiment may be practiced by removing the transistor YscL and including the driver 413c from a scan electrode driving circuit according to the first, second, third, fifth, and sixth exemplary embodiments of the present invention.

According to the present invention, because different voltage levels can be supplied using one power source, the quantity of power sources can be reduced in a plasma display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising a plasma display panel having a plurality of electrodes, an address electrode driver, a sustain electrode driver, and a scan electrode driver, the scan electrode driver comprising:
a first transistor having a first terminal coupled to an electrode of the plurality of electrodes and a second terminal coupled to a first power source for supplying a first voltage;
a first driver for controlling driving of the first transistor to change a voltage of the electrode; and
a second driver comprising a comparator having an output terminal and a plurality of first resistors coupled in series between the electrode and the first power source,
wherein the comparator is configured to output a high level voltage or a low level voltage to its output terminal by comparing a voltage generated by dividing a voltage of the electrode by the plurality of first resistors with a reference voltage, and
wherein the second driver sustains the voltage of the electrode at a second voltage that is different from the first voltage by turning off the first transistor during a first period in response to an output voltage of the comparator.

2. The plasma display device of claim 1, wherein the first voltage is lower than the second voltage.

3. The plasma display device of claim 2,
wherein the second driver comprises a second transistor whose first terminal and second terminal are coupled between a control terminal of the first transistor and the first power source, and whose control terminal is coupled to an output terminal of the comparator, and
wherein the second driver is configured to turn on the second transistor during the first period.

4. The plasma display device of claim 3, wherein the second transistor comprises a PNP-type transistor whose first terminal is an emitter, and whose second terminal is a collector, and
the second driver is configured to output the low level voltage to a base of the second transistor during the first period.

5. The plasma display device of claim 3, wherein the second transistor comprises an NPN-type transistor whose first terminal is a collector, and whose second terminal is an emitter, and
the second driver is configured to output the high level voltage to a base of the second transistor during the first period.

6. The plasma display device of claim 2,
wherein the second driver comprises a diode having an anode coupled to a control terminal of the first transistor, and a cathode coupled to the output terminal of the comparator, and
wherein the second driver is configured to output the low level voltage from the output terminal of the comparator during the first period.

7. The plasma display device of claim 2,
wherein the second driver comprises a second transistor having a first terminal and a second terminal coupled to the control terminal of the first transistor and the first terminal of the first transistor, respectively, and a control terminal coupled to the output terminal of the comparator, and
wherein the second driver is configured to turn off the second transistor during the first period.

8. The plasma display device of claim 7, wherein the second driver further comprises a diode coupled between the first terminal of the second transistor and the second terminal of the second transistor for forming a discharge path when the second transistor is turned off.

9. The plasma display device of claim 7, wherein the second transistor comprises an NPN-type transistor whose first terminal is an emitter and whose second terminal is a collector, and
the second driver is configured to output the low level voltage to the control terminal of the second transistor during the first period.

10. The plasma display device of claim 2, wherein the first driver comprises an amplifier for outputting a high level voltage or a low level voltage through its output terminal to a control terminal of the first transistor in response to a first control signal, and
the second driver is configured to supply a second control signal for turning off the first transistor during the first period.

11. The plasma display device of claim 10, wherein the amplifier comprises
a PNP-type transistor comprising an emitter coupled to a second power source for supplying the high level voltage, a collector coupled to the output terminal, and a base to which the first control signal is applied, and
an NPN-type transistor comprising an emitter coupled to a third power source for supplying the low level voltage, a collector coupled to the output terminal, and a base to which the first control signal is applied.

12. The plasma display device of claim 11, wherein the amplifier comprises a push-pull circuit.

13. The plasma display device of claim 11,
wherein the second driver further comprises a second transistor coupled between the control terminals of the PNP-type transistor and the NPN-type transistor and the first power source,
wherein a control terminal of the second transistor is coupled to the output terminal of the comparator, and
wherein the second driver is configured to turn on the second transistor during the first period.

14. The plasma display device of claims 2, the scan electrode driver further comprising a third driver for applying the first voltage to the electrode by turning on the first transistor during a second period.

15. The plasma display device of claim 14, wherein the third driver comprises
a control signal voltage source for supplying a control signal to a control terminal of the first transistor for turning on the first transistor, and
a diode for forming a current path from the control signal voltage source to the control terminal of the first transistor.

16. The plasma display device of claim 14, wherein the first period comprises a reset period, the second period comprises an address period, and the first voltage comprises a voltage applied to the electrode of a light emitting cell in the address period.

17. The plasma display device of claims 2, the scan electrode driver further comprising a third transistor coupled between the first power source and the electrode, and the third transistor configured to turn on during the second period to apply the first voltage to the electrode.

18. The plasma display device of claim 17, wherein the first period comprises a reset period, and the second period comprises an address period, and the first voltage comprises a voltage applied to the electrode of a light emitting cell in the address period.

19. A method of driving a plasma display device comprising a plasma display panel having a plurality of electrodes, an address electrode driver, a sustain electrode driver, and a scan electrode driver having a first transistor, comprising:
changing a voltage of an electrode of the plurality of electrodes by turning on the first transistor coupled between the electrode and a power source for supplying a first voltage during a first period of a reset period;
comparing a voltage generated by dividing a voltage of the electrode by a first resistor and a second resistor with a reference voltage, the first resistor and the second resistor coupled in series between the electrode and the power source; and
sustaining the voltage of the electrode to a second voltage during a second period of the reset period by turning off the first transistor when the divided voltage is lower than the reference voltage.

20. The method of claim 19, wherein the second voltage is higher than the first voltage.
